(19) United States
(12) Patent Application Publication
(10) Pub. No.: US 2006/0017255 A1
(43) Pub. Date: Jan. 26, 2006

(54) Bearing arrangement for a control arm for motor vehicles

(76) Inventors: Joachim Kappich, Bad Liebenzell (DE); Jan Pfingst, Sersheim (DE); Rainer Gebhardt, Weinstadt (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/182,828

(22) Filed: Jul. 18, 2005

(30) Foreign Application Priority Data
Jul. 16, 2004 (DE) 10 2004 034 580.5

(51) Int. Cl. B60G 7/00

(52) U.S. Cl. 280/124.134

(57) ABSTRACT

A control arm for a motor vehicle, such as a control arm for a front axle in a McPherson construction, has an inside bearing for connecting the control arm with a vehicle body, a wheel suspension bearing for connecting a wheel, and a strut bearing, which is constructed as a hydraulically damped bearing. In order to reduce bothersome torsional steering wheel vibrations, the inside body-side bearing of the control arm has a very stiff construction while the bearing used for the support has a soft construction and is hydraulically damped.

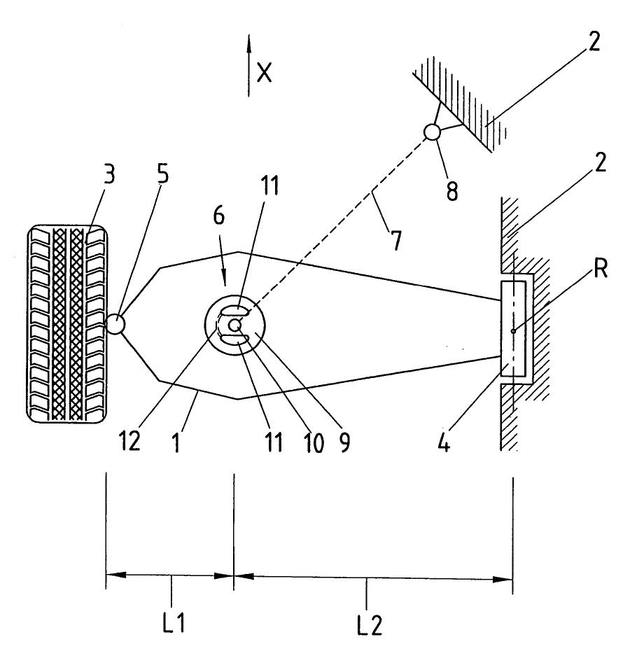

This application claims the priority of German application 10 2004 034 580.5, filed Jul. 16, 2004, the disclosure of which is expressly incorporated by reference herein.

### BACKGROUND AND SUMMARY OF THE INVENTION

The present invention relates to a bearing arrangement and to a control arm arrangement for a motor vehicle, such as a control arm arrangement for a front axle in a McPherson construction, including an inside vehicle-body-side bearing providing for connection of a control arm with a vehicle body, a wheel suspension bearing providing for connection of a wheel, and a strut bearing which is constructed as a hydraulically damped bearing,

A bearing for a control arm is known, for example, from German Patent Document DE 199 23 698 A1. A guiding joint for connection of a wheel or wheel carrier is situated opposite an inside bearing which connects the control arm with the vehicle body. For the support of longitudinal forces, a bent-away control arm section is provided on the control arm, and the control arm section accommodates a hydraulic bearing on the end side for a support on the vehicle body. The hydraulic bearing permits a hydraulic damping of the bearing. The inside bearing is constructed as a conventional bearing bush.

As a result of excitations from the tires and the road, so-called torsional steering wheel vibrations occur at the steered front axles; that is, the excitations at the front axle are transmitted into the steering wheel. It is an object of the invention to effectively reduce such torsional vibrations which are perceived to be bothersome.

The present invention is based on a recognition that a reduction of torsional vibrations of the steering wheel can particularly effectively take place by damping longitudinal vibrations at the front axle. Hydraulically damped bearings are suitable for this purpose. This presents the issue of optimally utilizing the damping capacity of the hydraulically damped bearings.

It is accordingly suggested to provide a very stiff construction of the inside vehicle-body-side bearing of the control arm, while the bearing used for the support has a soft construction and is hydraulically damped. In this case, the hydraulic damping is adjusted such that, relative to the inside body-side bearing as a swivelling point, it acts in a “radial” direction. It is advantageously achieved thereby that mainly swivelling motions of the control arm about the inside bearing are damped. Forces other than longitudinal forces, which are applied to the control arm, can therefore be supported in a suitable manner and without being influenced by the damping. The rigidly constructed inside bearing contributes significantly to effective damping; this bearing forms a swivelling point which essentially carries out no longitudinal movements. Swivelling movements of the control arm lead to a maximal movement at the strut bearing, and therefore also at the hydraulic damper, so that the undamped spring travels are short and the hydraulic damping particularly effective as a result.

Advantageous further developments are defined by the claims.

It is suggested to select the stiffness of the inside vehicle-body-side bearing so that it is at least twice as high as the stiffness of the strut bearing in the direction to be damped. For sporty vehicles, the stiffness of the inside body-side bearing may also be selected so as to be more than three times as high in order to achieve the appropriate compromise between wheel guiding characteristics and comfort.

Furthermore, it is suggested to construct the inside bearing as a ball joint. The damping effect of the hydraulically damped strut bearing is the highest in this embodiment.

The hydraulically damped strut bearing is preferably constructed as a hydraulic bush. Hydraulic bushes have direction-dependent damping and are therefore particularly suitable for application in the present case.

A bearing according to the invention is preferably used in a control arm in which the strut bearing is arranged between the inside body-side bearing and the wheel suspension bearing. In this case, a strut, which is supported in an articulated manner on the vehicle body side, is applied to the strut bearing.

### BRIEF DESCRIPTION OF THE DRAWINGS

An embodiment of the invention is illustrated in the single FIGURE, in which a control arm is shown as arranged between a vehicle body and a wheel.

### DETAILED DESCRIPTION OF THE INVENTION

A control arm 1 of a front axle of a motor vehicle, which is not shown, is arranged between a vehicle body 2 and a wheel 3. An inside vehicle-body-side bearing 4 between the vehicle body 2 and the control arm 1 is constructed as a bush bearing. A wheel suspension bearing 5 arranged between the wheel 3 and the control arm 1 is constructed as a ball joint. A strut bearing 6 is provided in the control arm 1 and is situated approximately on a line between the wheel suspension bearing 5 and the inside bearing 4. A strut 7 is applied to the strut bearing 6, which strut 7 is hinged to the vehicle body 2 by means of another bearing 8.

The strut bearing 6 is constructed as a hydraulic bush 9 which is known per se and in the case of which two opposite chambers 11 are provided in an elastic base material on both sides of a bearing point 10 to which the strut 7 is applied, which chambers 11 are filled with a hydraulic fluid. The chambers 11 are mutually connected by means of a connection line 12. The design of the connection line 12 decisively defines the damping characteristics of the hydraulic bush 9. The position of the chambers 11 determines the direction of the greatest damping effect of the hydraulic bush 9.

The hydraulic bush 9 is arranged in the control arm 1 in such a manner that, relative to a swivelling point R of the control arm 1 which is formed by the inside bearing 4, its chambers 11 are situated in the radial direction beside the fastening point 10. In the present example, this is the longitudinal direction X of the vehicle because the strut bearing 6 is arranged perpendicular to the direction X beside the inside bearing 4.

In the present example, the stiffness of the inside bearing 4 in direction X amounts to 3.75 times the stiffness of the strut bearing 6. This has the effect that displacements in direction X, which are introduced, for example, from the wheel 3 into the control arm 1, lead only to a very small movement at the bearing 4 while clearly greater movements can be determined at the strut bearing 6. These greater movements can be easily damped there by using the hydraulic bush 9.

The distance L1 between the wheel suspension bearing 5 and the strut bearing 6 is selected to be as small as permitted by the mounting space. In this manner, longitudinal movements or vibrations of the wheel 3 generate maximal movements in the strut bearing 6 and thus in the hydraulic bush 9, which contributes to optimizing the damping. The reference symbol L2 indicates the distance between the strut bearing 6 and the inside body-side bearing 4. The distance L2 is clearly greater than the distance L1.

Since the strut 7 by which the hydraulic bush 9 is supported is connected with the vehicle body 2 in an articulated manner, the hydraulic bush 9 is exposed only to forces other than axial and cardanic loads, which are largely avoided. This contributes to the improvement of the structural durability of the hydraulic bush 9.

The control arm 1 functions such that, during longitudinal movements of the wheel 3 on the front axle, normally, vibrations are transmitted to the steering wheel via the steering rod (not shown) to the steering gear (not shown). To prevent this, the strut bearing 6 is arranged in the control arm so that the movements in the longitudinal direction can be damped. This occurs by supporting the strut with the hydraulic support provided by way of the strut bearing 6 during vibrating movements of the control arm 1 in the vehicle longitudinal direction. The constant back and forth movements of the control arm cause the hydraulic fluid to be redirected via the connecting channel in the hydraulic chambers 11. This causes a damping effect.

The inside-body-side bearing 4 is designed as an elastic bearing; however, this bearing is dimensioned stiff enough for a pivot point to form within the bearing. If this bearing is too soft, the pivot point will move towards the link in the direction of the strut bearing, worsening the effect considerably.

During operation of the control arm arrangement, the wheel 3 moves back and forth in the vehicle longitudinal direction, resulting in vibrations. Since the strut 7 is supported in the bearing 6, however, pressure can be applied to a corresponding chamber 11 by pressing or pulling, thus redirecting the hydraulic fluid via the channel 12 and damping the oscillating movement.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A transverse control arm arrangement for motor vehicles comprising:
an inside vehicle-body-side bearing providing for connection of a control arm with a vehicle body,
a wheel suspension bearing providing for connection of a wheel, and
a strut bearing which is constructed as a hydraulically damped bearing,
wherein the inside bearing has a very stiff construction at least with respect to the strut bearing in a longitudinal direction of the vehicle,
wherein the inside bearing forms a swivelling point for the control arm, and
wherein the strut bearing includes chambers with hydraulic fluid which are connected to each other via a connection line.

2. The control arm arrangement according to claim 1, wherein the inside bearing has a stiffness selected to be at least twice as high as a stiffness of the strut bearing in a direction in which movement is to be damped.

3. The control arm arrangement according to claim 1, wherein the inside bearing is constructed as a ball joint.

4. The control arm arrangement according to claim 1, wherein the strut bearing is constructed as a hydraulic bush.

5. The control arm arrangement according to claim 1, wherein the strut bearing is arranged between the inside bearing and the wheel suspension bearing, and wherein a strut which is supported at the vehicle body in an articulated manner is applied to the strut bearing.

6. The control arm arrangement according to claim 1, wherein the arrangement is for a front-axle in a McPherson construction.

7. The control arm arrangement according to claim 2, wherein the stiffness of the inside bearing is selected to be at least three times as high as the stiffness of the strut bearing.

8. The control arm arrangement according to claim 2, wherein the inside bearing is constructed as a ball joint.

9. The control arm arrangement according to claim 2, wherein the strut bearing is constructed as a hydraulic bush.

10. The control arm arrangement according to claim 3, wherein the strut bearing is constructed as a hydraulic bush.

11. The control arm arrangement according to claim 2, wherein the strut bearing is arranged between the inside bearing and the wheel suspension bearing, and wherein a strut which is supported at the vehicle body in an articulated manner is applied to the strut bearing.

12. The control arm arrangement according to claim 3, wherein the strut bearing is arranged between the inside bearing and the wheel suspension bearing, and wherein a strut which is supported at the vehicle body in an articulated manner is applied to the strut bearing.

13. The control arm arrangement according to claim 4, wherein the strut bearing is arranged between the inside bearing and the wheel suspension bearing, and wherein a strut which is supported at the vehicle body in an articulated manner is applied to the strut bearing.

14. The control arm arrangement according to claim 6, wherein the strut bearing is arranged between the inside bearing and the wheel suspension bearing, and wherein a strut which is supported at the vehicle body in an articulated manner is applied to the strut bearing.

15. The control arm arrangement according to claim 7, wherein the strut bearing is arranged between the inside bearing and the wheel suspension bearing, and wherein a strut which is supported at the vehicle body in an articulated manner is applied to the strut bearing.

16. The control arm arrangement according to claim 8, wherein the strut bearing is arranged between the inside bearing and the wheel suspension bearing, and wherein a strut which is supported at the vehicle body in an articulated manner is applied to the strut bearing.

17. The control arm arrangement according to claim 9, wherein the strut bearing is arranged between the inside bearing and the wheel suspension bearing, and wherein a strut which is supported at the vehicle body in an articulated manner is applied to the strut bearing.

18. The control arm arrangement according to claim 10, wherein the strut bearing is arranged between the inside bearing and the wheel suspension bearing, and wherein a strut which is supported at the vehicle body in an articulated manner is applied to the strut bearing.

19. A bearing arrangement adapted to support a transverse control arm arrangement for motor vehicles comprising:
an inside vehicle-body-side bearing,
a wheel suspension bearing, and
a strut bearing, which is constructed as a hydraulically damped bearing,
wherein the inside bearing has a very stiff construction at least with respect to the strut bearing in a longitudinal direction,
wherein the inside bearing forms a swivelling point for a control arm, and
wherein the strut bearing includes chambers with hydraulic fluid which are connected to each other via a connection line.

20. A bearing arrangement according to claim 19, wherein the inside bearing has a stiffness selected to be at least twice as high, as a stiffness of the strut bearing in a direction in which movement is to be damped.
